(19) United States
(12) Patent Application Publication
(10) Pub. No.: US 2020/0239765 A1
(43) Pub. Date: Jul. 30, 2020

(54) QUANTUM DOT FILM WITH POLYMER BEADS

(71) Applicant: SABIC GLOBAL TECHNOLOGIES B.V., Bergen op Zoom (NL)

(72) Inventors: Changmin LEE, Gyeonggi-do (KR); Hyunjin KANG, Gyeonggi-do (KR); Namhun KIM, Daejeon (KR); Daekyung KIM, Seoul (KR); Heeyeop CHAE, Seoul (KR); Seongwon KIM, Seoul (KR); Jong Woo LEE, Seoul (KR); Soonyoung HYUN, Gyeonggi-do (KR); Kahee SHIN, Seoul (KR); Sunyoung LEE, Gyeonggi-do (KR); Jeongmin LIM, Gyeonggi-do (KR); Chunim LEE, Seoul (KR)

(21) Appl. No.: 16/637,327

(22) PCT Filed: Aug. 7, 2018
(86) PCT No.: PCT/IB2018/055950

§ 371 Date: Feb. 7, 2020

Related U.S. Application Data
(60) Provisional application No. 62/541,938, filed on Aug. 7, 2017.

(51) Int. Cl. C09K 11/02; C09K 11/88

(52) U.S. Cl. CPC C09K 11/025; B82Y 20/00; C09K 11/883

(57) ABSTRACT

Provided are compositions comprising quantum dots bearing organic ligands, the quantum dots being disposed onto polymeric particles, and the polymeric particles in turn being dispersed into a medium. The compositions are characterized by enhanced dispersion of the quantum dots and improve the performance of display devices that include the compositions.

### TECHNICAL FIELD

The present disclosure relates to the field of quantum dot compositions, in particular to the field of quantum dot compositions useful in display technologies.

### BACKGROUND

Some existing image display technologies utilize quantum dot (QD) materials to modulate the colors of the image, with the QDs being disposed in a matrix material film. In these commercial displays, however, the QDs disposed in the film matrix are often aggregated, and as a consequence, emitted light of the display may shift to longer wavelengths (i.e., red-shifted wavelengths), which may affect the overall performance of the display. Hence, in order to maximize the light efficiency of the QDs disposed in the matrix, one must disperse QDs in a manner sufficient to prevent FRET (fluorescence resonance energy transfer) between adjacent nanoparticles.

Although a certain level of QD concentration may be needed to achieve the desired illumination performance of the display, at the same time, as the concentration of QDs in the QD film increases, the distance among adjacent QD particles statistically decreases, which in turn causes high QD aggregation and undesirable quenching effects. Because of these competing effects, the photoluminescence of QD film shows a maximum intensity at a certain level of QD concentration, as higher levels of QD concentration may result in quenching. The maximum level of intensity, however, may be below the desired maximum level of intensity.

These and other shortcomings are addressed by aspects of the disclosure.

### SUMMARY

In meeting the long-felt needs described above, the present disclosure provides QD compositions (which may be present as, e.g., layers and/or films) that comprise organic ligand-bearing QDs disposed onto polymeric particles (termed “beads,” in some instances). Without being bound to any particular theory, the polymeric beads may facilitate the dispersion of QDs in the composition due to the steric hindrance between beads. By modulating the association between QD particles and polymeric beads via the presence of organic ligands, one can achieve beneficial levels of QD dispersion and concentration of the QDs.

In one aspect, the present disclosure provides compositions, comprising: a population of QDs dispersed on a population of polymeric particles, one or more organic ligands being disposed on the surfaces of the QDs, and the population of polymeric particles being dispersed in a matrix material.

In another aspect, the present disclosure provides methods of preparing a composition, comprising: in a dispersion medium, contacting a population of QDs, an organic ligand, and a population of polymeric particles under such conditions that the QDs are dispersed on the population of polymeric particles, the organic ligand participating in the dispersion of the QDs on the polymeric particles.

Further provided are compositions prepared according to the disclosed methods.

Additionally provided are methods, comprising: dispersing, into a matrix material, a population of polymeric particles having disposed thereon a population of QDs bearing organic ligands.

### BRIEF DESCRIPTION OF THE DRAWING

The following is a brief description of the drawings wherein like elements are numbered alike and which are exemplary of the various aspects described herein. In the drawing:

FIG. 1 provides illustrative photoluminescence (PL) intensity vs. QD loading data for a reference composition and a sample composition according to the present disclosure.

FIGS. 2A and 2B are graphs illustrating the effect of QD concentration on PL.

FIG. 3 is a graph comparing the PL intensity of a QD solution, a QD composition including polymer beads, and a QD cast film.

FIG. 4 provides scanning electron microscope (SEM) images of various QD configurations.

FIG. 5A is a schematic representation of QDs and polymer beads.

FIG. 5B is a SEM image of QDs and polymer beads and a polymer film including the same.

FIG. 6 is a schematic representation of dispersion of QDs around a polymeric bead.

### DETAILED DESCRIPTION OF ILLUSTRATIVE ASPECTS

The present disclosure may be understood more readily by reference to the following detailed description of desired aspects and the examples included therein.

The present disclosure provides, inter alia, QD-containing compositions that exhibit improved photoluminescence (PL) properties, especially as compared to existing such compositions.

More specifically, the presently-disclosed compositions include polymeric particles (termed beads, in some instances) that have disposed on their surfaces QDs that themselves bear organic ligands on their surfaces. The polymeric particles are in turn dispersed within a matrix material.

Without being bound to any particular theory, the organic ligands may affect the association of the QDs with the polymeric particles. The organic ligands may, in some instances, act to maintain an association between a QD and the polymeric particle with which the QD is associated; the spacing between the QD and the polymer particle may be on the order of the length of the ligand.

Without being bound to any particular theory, an organic ligand may effect (e.g., give rise to or otherwise modulate) association of the QD and the polymeric particle. In some aspects, an organic ligand may be bound (covalently, ionically, or via hydrogen bonding) to one or both of the QD and the polymeric particle. In some aspects, the association between the ligand and the QD, the polymeric particle, or both, may be a dipole-dipole interaction. Pi-pi orbital stacking and other non-covalent bonding may also be present between the ligand and the QD and/or the ligand and the polymeric particle.

As described elsewhere herein, QDs need not be bound directly (e.g., covalently) to the polymeric particles, as the organic ligands mediate the association of the QDs and the polymeric particles. It should also be understood that QDs may be associated solely with the exterior surface of a polymeric particle; it is not necessary that QDs be present within the particle or are otherwise incorporated into the bulk material of the particle.

Without being bound to any particular theory, the polymeric beads may facilitate the overall dispersion of QDs within the matrix due to the steric hindrance between the polymeric beads. These steric effects may, in some aspects allow for a consistent and well-controlled dispersion of QDs within the overall composition, as the steric effects may give rise to a predictable and uniform separation between polymeric particles. This predictable separation of the particles in turn translates into a predictable overall dispersion of the QDs associated with the particles.

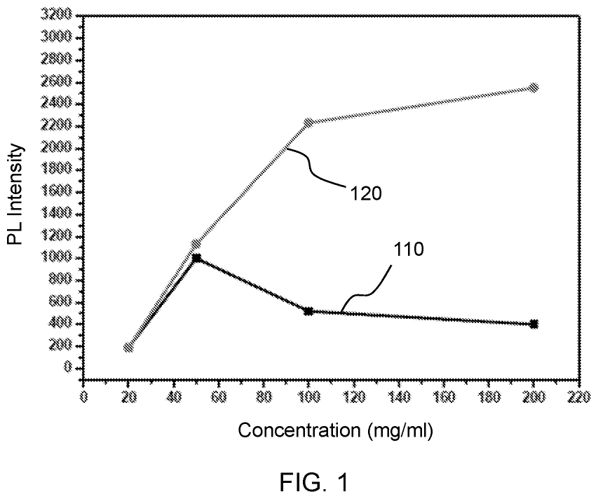

At present, a user may wish to enhance the performance of a QD-containing composition used in a display or other device by adding more QDs to the composition. Doing so, however, can result in a quenching effect, as QDs can aggregate and even quench one another as they may be present within a certain distance from one another. Indeed, as shown in FIG. 1, a given composition according to the present state of the art may exhibit a PL maximum at a critical QD concentration, above which critical QD concentration the QDs aggregate and/or quench one another. Thus, existing QD compositions have a maximum PL performance—but that PL performance may not be sufficient for a user's needs or objectives.

The presently-disclosed compositions, however, may permit a PL performance that exceeds the maximum PL performance of an existing QD composition according to the present state of the art. As explained above, the disclosed technology allows for uniform dispersion of QDs within an overall matrix, and the steric hindrance between the QD-bearing polymeric particles may in turn prevent the QDs on those particles from aggregating and/or quenching one another. In this way, one may continue to increase the loading of QDs in a given composition without facing the problem of those QDs aggregating and/or quenching one another, as (again, without being bound to any particular theory) the steric forces between polymeric particles and the ligand-mediated associations between QDs and the polymeric particles act to reduce (or even prevent) QDs from aggregating and/or quenching one another.

Thus, by using the polymeric particles system to modulate the associations of QDs with one another, one can achieve beneficial levels of QD dispersion and concentration of the QDs. Through use of the disclosed technology, one may in turn form QD compositions that exhibit PL performance that exceeds that of existing QD compositions, as well as PL performance equal to that of existing QD compositions at comparatively lower levels of QD loading, thus reducing cost and/or complexity while providing equivalent or improved performance relative to existing approaches.

As one example of the advantages of the disclosed technology, compositions according to the present disclosure may exhibit a PL that is greater than the maximum PL of an existing QD composition according to the present state of the art at the same QD loading level that corresponds to the loading level that gives rise to the maximum PL in the existing QD composition. Without being bound to any particular theory, this improved performance may be attributable to the steric and other forces between the polymeric particles of the presently disclosed compositions reducing or even preventing aggregation of QDs and/or QDs quenching one another.

As another example of the advantages of the disclosed technology, compositions according to the present disclosure may exhibit a PL that increases with increasing QD loading levels beyond the QD loading level that gives rise to the maximum PL in a correspondence reference composition (i.e., a QD composition that includes QDs dispersed in the same matrix as the matrix of the disclosed composition, but does not also feature organic ligands that give rise to association between the QDs and polymeric particles).

As a still further advantage, a (sample) composition according to the present disclosure may be characterized as having, at a given QD concentration, a photoluminescence intensity that is greater than the maximum photoluminescence intensity of a corresponding reference composition that is free of the polymer particles and the organic ligands but otherwise identical to the sample composition.

The present disclosure also provides, e.g., methods of forming compositions. These methods may include contacting polymeric particles with organic ligand-bearing QDs such that the organic ligands give rise to association between the QDs and the polymeric particles. The methods may further include dispersing the QD-ligand-polymeric particles into a matrix material, and may even comprise forming the matrix material into layer form.

In one aspect, a layer of the disclosed compositions may be disposed such that the layer is in optical communication with an illumination source, e.g., a blue or other color LED. As one example, QDs may be used to improve LED backlighting, whereby light from a blue LED is converted by QDs to relatively pure red and green light. This combination of blue, green and red light incurs less absorption of unwanted colors by the color filters behind the LCD screen, thereby increasing useful light throughput and providing a better so-called color gamut.

In the following specification and the claims that follow, reference may be made to a number of terms which have the following meanings.

Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the aspects “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Numerical values in the specification and claims of this application, particularly as they relate to polymers or polymer compositions, oligomers or oligomer compositions, reflect average values for a composition that may contain individual polymers or oligomers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only.

As shown in FIG. 1, the photoluminescence of ordinary QD film (line 110) shows a maximum as a function of increasing QD concentration, as QD particles start to aggregate and consequently the particles lose quantum yield by photoluminescence quenching when the amount of QD exceed certain level of concentration. As shown in FIG. 1, however, a sample QD film incorporated with QD-bearing polymeric beads (line 120) exhibits a comparatively higher photoluminescence compared with an ordinary QD film because dispersion in the sample film is comparatively well-maintained at high level of QD concentrations, as shown in FIG. 1. Without being bound to any particular theory, application of the present QD-polymer bead technology to a given QD system enables double the photoluminescence intensity that can be achieved by an existing QD-in-matrix system according to the current state of the art. Again without being bound to any particular theory, the polymeric beads may act as scattering beads for elongating light pathways. Hence by controlling the polymeric beads' size and refractive index, one may further improve quantum efficiency.

Exemplary Aspects

The following aspects are exemplary only and accordingly do not limit the scope of the present disclosure or the appended claims.

Aspect 1. A composition, comprising: a population of QDs disposed on a population of polymeric particles, one or more organic ligands being disposed on the surfaces of the QDs, and the population of polymeric particles being dispersed in a matrix material.

QDs exhibit properties that are intermediate between those of bulk semiconductors and those of discrete molecules. Their optoelectronic properties may change as a function of both size and shape. Comparatively larger QDs (radius of 5-6 nanometers (nm), for example) may longer wavelengths resulting in emission colors such as orange or red. Smaller QDs (radius of 2-3 nm, for example) emit shorter wavelengths resulting in colors like blue and green, although the specific colors and sizes vary depending on the exact composition of the QD.

In some aspects, the organic ligands may mediate the association of the QDs with the polymeric particles. As one example, the organic ligands may act as a “bridge” between the QDs and the polymeric particles; thus, QDs need not be bound directly (e.g., covalently) to the polymeric particles, as the organic ligands mediate the association of the QDs and the polymeric particles. It should be understood that the QDs are disposed on the outer surfaces of the polymeric particles, similar to the panels disposed along the outer surface of a soccer ball. QDs may be uniformly disposed along the outer surfaces of the polymeric particles, though this is not a requirement.

The population of quantum dots (QDs) may be homogeneous in terms of size, composition, or both, but this is not a requirement. For example, a composition may comprise two populations of QDs, e.g., a population of CdSe QDs having an average diameter of about 4 nm, and a population of MgS QDs, having an average diameter of about 3 nm. Thus, a composition may comprise two populations of QDs, which populations differ from one another in at least one aspect, e.g., material composition or size.

Aspect 2. The composition of aspect 1, wherein the organic ligand comprises an amine (e.g., an amine bound to an alkyl group having from 6 to 30 carbons—a C6-C30 alkylamine), a carboxylic acid, a thiol, a phosphine, a pyridine, or any combination thereof. The amine, carboxylic acid, thiol, phosphine, or pyridine may be bound to an alkane, alkene, or alkyne, which hydrocarbon may be linear, branched, or cyclic. N-butane-thiol is considered a suitable organic ligand. Fatty acids may be used as organic ligands.

Exemplary chains that may be bound to the amine, carboxylic acid, thiol, phosphine, or pyridine include C1-C30 hydrocarbons, including linear, branched, and cyclic aspects of such hydrocarbons.

In aspects where the polymeric particles comprise a hydrophobic polymer, carboxylic acid, amine, and thiol compounds with alkyl groups are considered particularly suitable ligands. It should be understood that the polymeric particles may be pure polymer, but may also include metals or other functional groups. Polymeric particles may be bare polymer, but may also include a surface coating, e.g., a metallic coating.

One exemplary (but non-limiting) combination of matrix polymer, bead, ligand, and QD is:

Matrix polymer: Polycarbonate (PC)

Polymeric particle (also termed “bead,” in some instances): Polymethylmethacrylate (PMMA)

Ligand: Oleic acid [CH₃(CH₂)₇CH═CH(CH₂)₇COOH] or octane thiol [CH₃(CH₂)₆CH₂SH]

QD: CdSe (core)/ZnS (shell)

Aspect 3. The composition of any of aspects 1-2, wherein the organic ligand comprises a C6-C30 alkylamine, a carboxylic acid, a thiol, or any combination thereof.

Aspect 4. The composition of any of aspects 1-2, wherein the organic ligand has a molecular weight of from about 90 to about 350 grams per mole (g/mol), e.g., from about 90 to about 350 g/mol, from about 100 to about 340 g/mol, from about 110 to about 330 g/mol, from about 120 to about 320 g/mol, from about 130 to about 310 g/mol, from about 140 to about 300 g/mol, from about 150 to about 290 g/mol, from about 160 to about 280 g/mol, from about 170 to about 270 g/mol, from about 180 to about 260 g/mol, from about 190 to about 250 g/mol, from about 200 to about 240 g/mol, or even from about 210 to about 230 g/mol.

Aspect 5. The composition of any of aspects 1-3, wherein the polymeric particles comprise one or more of: acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAD, a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), polycarbonate polymer (PC), polymethylmethacrylate polymer (PMMA), or any combination thereof. Poly carbonate (PC), poly styrene (PS), acrylonitrile butadiene styrene (ABS), and poly acrylate polymers are considered especially suitable.

Aspect 6. The composition of any of aspects 1-4, wherein the population of polymeric particles has a mean (number average) size in the range of from about 100 nm to about 10 micrometers. The population of particles may have a mean size of, e.g., from about 100 nm to about 10,000 nm, or from about 200 nm to about 9500 nm, or from about 300 nm to about 9000 nm, or from about 350 nm to about 8500 nm, or from about 400 nm to about 8000 nm, or from about 450 nm to about 7500 nm, or from about 500 nm to about 7000 nm, or from about 600 nm to about 6500 nm, or from about 700 nm to about 6000 nm, or from about 800 nm to about 5500 nm, or from about 900 nm to about 5000 nm, or even from about 1000 nm to about 4500 nm. The average size may be determined by, e.g., scanning electron microscopy (SEM) or optical microscopy; number average. Particle mean sizes in the range of from about 1 micrometer (i.e., 1000 nm) to about 10 micrometers (i.e. 10,000 nm) are considered especially suitable.

Aspect 7. The composition of aspect 6, wherein the wherein the population of polymeric particles has a mean (number average) size in the range of from about 1 micrometer to about 5 micrometers, e.g., from about 1.5 to about 4.5 micrometers, from about 2 to about 4 micrometers, or even from about 2.5 to about 3.5 micrometers.

Aspect 8. The composition of any of aspects 1-7, wherein the population of QDs comprises a group II-VI element, a group II-V element, a group III-V element, a group III-VI element, a group IV-VI semiconductor, or any combination thereof.

Aspect 9. The composition of any of aspects 1-8, wherein the population of QDs comprises a group II-VI element.

Aspect 10. The composition of aspect 9, wherein the population of QDs comprises MgS, MgSe, MgTe, CaS, CaSe, CaTe, SrS, SrSe, SrTe, CdS, CdSe, CdTe, ZnS, ZnSe, ZnTe, HgS, HgSe, HgTe, or any combination thereof. (It should be understood that a QD in this or any other aspect of the presently disclosed technology may be a homogenous QD, but it may also have a core-shell structure.) CdS, CdSe, and ZnSe are especially suitable QD materials.

Aspect 11. The composition of aspect 8, wherein the population of QDs comprises a group II-V element.

Aspect 12. The composition of aspect 11, wherein the population of QDs comprises Zn₃P₂, Zn₃As₂, Cd₃P₂, Cd₃As₂, Cd₃N₂, Zn₃N₂.

Aspect 13. The composition of aspect 8, wherein the population of QDs comprises a group III-V element.

Aspect 14. The composition of aspect 13, wherein the population of QDs comprises B₄C, Al₄C₃, Ga₄C, or any combination thereof.

Aspect 15. The composition of aspect 8, wherein the population of QDs comprises a group III-VI element.

Aspect 16. The composition of aspect 15, wherein the population of QDs comprises AlS₃, Al₂Se₃, Al₂Te₃, Ga₂S₃, Ga₂Se₃, In₂S₃, In₂Se₃, Ga₂Te₃, In₂Te₃, or any combination thereof.

Aspect 17. The composition of aspect 8, wherein the population of QDs comprises a group IV-VI element.

Aspect 18. The composition of aspect 17, wherein the population of QDs comprises PbS, PbSe, PbTe, SnS, SnSe, SnTe, or any combination thereof. PbS and PbSe are considered especially suitable.

Aspect 19. The composition of any of aspects 1-18, wherein the QDs are present at from about 0.05 to about 5 wt % per volume of the composition.

For example, the QDs may be present at from about 0.05 to about 4.5 wt %, from about 0.05 to about 1 wt %, or from about 0.05 to about 2 wt %, or from about 0.1 to about 1.5 wt %, or from about 0.1 to about 1.0 wt %, or even from about 0.1 to about 0.8 wt %.

As one non-limiting example, if one assumes QDs having a diameter or about 10 nm, particles having a diameter of about 1 micrometer and a density of about 1 gram per cubic centimeter (g/cm³), and the QDs being of CdS and having a density of a 4.8 g/cm³, one arrives at the QDs being present at about 0.1 wt % and the particles being present at about 10 wt %. In the foregoing example, the QDs are present at about 2×10³ QDs/particle.

QDs may be present at, e.g., up to about 10⁴ QDs/polymer particle. QDs may be present at from about 1000 to about 10,000 QDs per particle, e.g., from about 1000 to about 9000, from about 1500 to about 8500, from about 2000 to about 8000, from about 2500 to about 7500, from about 3000 to about 7000, from about 3500 to about 6500, from about 4000 to about 6000, or even from about 5000 to about 5000 QDs/particle.

Aspect 20. The composition of any of aspects 1-19, wherein the polymeric particles are present at from about 5 to about 50 wt % per volume of the composition.

As but some examples, the polymeric particles may be present at from about 1 to about 50 wt % of the composition, or from about 1 to about 30 wt % of the composition, or from about 1 to about 20 wt % of the composition, or from about 5 to about 20 wt % of the composition, or from about 5 to about 10 wt % of the composition.

Aspect 21. The composition of any of aspects 1-20, wherein the composition is characterized as being in layer form. The layer may be considered a film, in some instances.

Aspect 22. The composition of aspect 21, wherein the layer defines a thickness in the range of from about 10 to about 500 micrometers.

For example, the layer may define a thickness in the range of from about 10 to about 500 micrometers, or from about 50 to about 450 micrometers (e.g., from about 50 to about 300 micrometers), or from about 100 to about 400 micrometers, or from about 150 to about 350 micrometers, or from about 200 to about 300 micrometers, or even about 250 micrometers.

Aspect 23. The composition of any of aspects 1-22, wherein the matrix material comprises a curable resin, e.g., polycarbonate (PC). Photo and thermal curable acrylic resins as well as epoxy resins are considered especially suitable for the matrix composition. In some aspects, the matrix material may have a greater than 95% transmittance in the visible range (i.e., about 390 to about 770 nm), at a layer thickness of from about 100 to about 300 micrometers.

Aspect 24. The composition of aspect 23, wherein the resin comprises a thermally-curable resin.

Aspect 25. The composition of aspect 23, wherein the resin comprises an ultraviolet-curable resin.

Aspect 26. The composition of any of aspects 1-23, wherein the resin comprises one or more of a bis(organosiloxane)-functional amine, an epoxy-functional organosiloxane, an organosiloxane comprising a isocyanate group or an isocyanurate group, a bis(organosiloxane)-functional amine, or any combination thereof. Vinylorganosiloxane and organosiloxanehydride are considered (singly and in combination) especially suitable.

Aspect 27. The composition of any of aspects 1-26, further comprising one or more solvents, polymerization initiators, antioxidants, leveling agents, antifogging agents, antifouling agents, or coating control agents. An additive may be selected to enhance the uniformity of the thickness of the composition when the composition is applied to a surface.

Aspect 28. The composition of any of aspects 1-27, wherein the composition is characterized as having a photoluminescence (PL) intensity that increases with increasing QD concentration at above the QD concentration that corresponds to the maximum photoluminescence intensity in a corresponding reference composition that is free of the polymer particles and the organic ligands.

This may be shown by reference to FIG. 1, which FIG. shows that the PL intensity for an exemplary composition (“QD/polymer bead”) according to the present disclosure increases (with increasing QD loading) beyond the maximum PL intensity for a corresponding QD reference composition (“casting film”) that is free of the polymer particles and organic ligands of the exemplary composition. This characteristic of the claimed compositions represents an advance over the state of the art, as the claimed compositions may attain PL intensities that exceed the maximum PL intensities attainable by currently used compositions.

Aspect 29. The composition of any of aspects 1-28, wherein the composition is characterized as having, at a QD concentration, a photoluminescence intensity that is greater than the maximum photoluminescence intensity of a corresponding reference composition that is free of the polymer particles and the organic ligands.

This may also be shown by FIG. 1, which FIG. illustrates that the maximum PL intensity for a composition according to the present disclosure may be greater than the maximum PL intensity for a corresponding reference QD combination that is free of the polymer particles and organic ligands.

Aspect 30. The composition of any of aspects 1-29, wherein the composition is characterized as having at a given QD concentration, a photoluminescence intensity that is equal to the maximum photoluminescence intensity of a corresponding reference composition that is free of the polymer particles and the organic ligand, and wherein the given QD concentration is lower than the QD concentration that produces the maximum photoluminescence intensity of the corresponding reference composition.

Putting this in another way, at the QD concentration (QDx) that produces the maximum PL intensity in a reference composition that lacks the organic ligands and polymer particles of the disclosed compositions, a composition according to the present disclosure that has a QD concentration of QDx may exhibit a PL intensity that is higher than the maximum PL intensity of the corresponding reference composition.

In some aspects, at a given QD concentration QD_{g}, a composition according to the present disclosure may exhibit a PL intensity at QD_{g} that is higher than the PL intensity achieved by a corresponding reference composition at a QD concentration of QD_{g}.

Aspect 31. The composition of any of aspects 1-30, wherein the composition is disposed on a substrate. Suitable substrates include, e.g., glasses, polymers, and the like. The substrate is suitably transparent, although this is not a requirement.

Aspect 32. The composition of any of aspects 1-31, wherein the composition comprises a part of a display device.

Suitable such display devices include, e.g., computer monitors, televisions, tablet computers, mobile telecommunications devices (e.g., smartphones), calculators, appliances, automotive displays, billboards, advertisements, transit station displays, aerospace displays, shipboard displays, and the like. The present technology is especially suitable for televisions, computing displays, tablet computers, and mobile devices.

Aspect 33. The composition of any of aspects 1-32, wherein the composition is in optical communication with an illumination source. This may be accomplished by, e.g., disposing the illumination source on one side of a layer of the composition such that the illumination source is in optical communication with the communication.

Aspect 34. The composition of aspect 33, wherein the illumination source is characterized as a light-emitting diode (LED). Blue LEDs are considered especially suitable, but other-colored LEDs (e.g., red, white) may also be used.

Because LEDs are well-known in the field and are already in use in many display technology devices, the present technology represents a “drop-in” solution to the shortcomings of existing displays. Put another way, the disclosed compositions allow one to begin with an existing display device, remove the display portion, and replace that display portion with a display portion that includes a composition according to the present disclosure. In this way, the disclosed technology allows display manufacturers to achieve a straightforward improvement of their devices simply by replacing the existing display with a display according to the present disclosure, as a display according to the present disclosure may exhibit improved PL intensity performance over the replaced display.

Aspect 35. A method of preparing a composition, comprising: in a dispersion medium, contacting a population of QDs, an organic ligand, and a population of polymeric particles under such conditions that the QDs are dispersed on the population of polymeric particles, the organic ligand participating in the dispersion of the QDs on the polymeric particles.

Suitable dispersion media include, e.g., water, organic solvents, monomer dispersions, polymer dispersions, acids, bases, and the like. Suitable QDs, organic ligands, and polymeric particles are all described elsewhere herein.

In some aspects, the organic ligand is already associated with the QDs, e.g., the QDs already bear the organic ligand before the QDs (and organic ligands) contact the population of polymeric particles. In other aspects, the organic ligand associates with the QDs in the dispersion medium. A user may modulate conditions within the dispersion medium (temperature, pH, salt content, and the like) to give rise to the desired association between the QDs, ligands, and polymeric particles.

The foregoing process of dispersing ligand-bearing QDs onto polymeric particles may be done in a so-called “one pot” process in which all species are introduced into a single vessel.

Aspect 36. The method of aspect 35, further comprising removing the dispersion medium. The removal may be performed via application of heat, reduced pressure, or both. The dispersion medium may also be removed via draining or even via filtration.

Aspect 37. The method of aspect 36, whereby the method is performed so as to give rise to a composition according to any of aspects 1-34.

Aspect 38. A composition prepared according to any of aspects 35-37.

Aspect 39. A method, comprising dispersing, into a matrix material, a population of polymeric particles having disposed thereon a population of QDs bearing organic ligands. Suitable matrix materials, QDs, polymeric particles, and organic ligands are described elsewhere herein. The matrix material may then be cured or otherwise solidified.

The matrix material may be placed into layer form, which layer may be free-standing (e.g., the layer may be removed form a supporting substrate after the matrix material is cured). The layer may also be formed on a supporting substrate, e.g., glass, polymer, silicon, and the like. In some aspects, a user may form multiple, discrete layers of matrix material having disposed therein polymeric particles having disposed thereon a population of QDs bearing organic ligands. Separate layers may differ from one another in terms of thickness, composition, or both.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

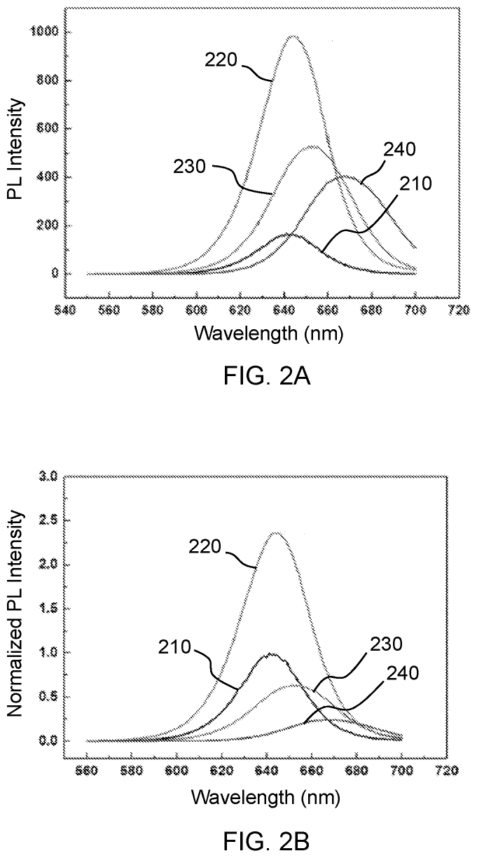

FIGS. 2A and 2B show the effect of quantum dot concentration on photoluminescence (PL) (no polymer beads). FIG. 2A shows PL intensity v. wavelength (in nanometers) for QD film having concentrations of 20 milligram (mg) (210), 50 mg (220), 100 mg (230) and 200 mg (240). FIG. 2B shows the normalized PL intensity of QD films having these same QD concentrations. The QDs used in this example are CdSe/_{Zn1-x}CdxS quantum dots having a nominal photoluminescence of 642 nm. As illustrated, PL intensity increases substantially with a QD concentration of 50 mg (compare 210 to 220). As QD concentration is increased to greater than 50 mg, however, (230 and 240), PL intensity decreases. In addition, the peak wavelength of the film shifts to red—from about 640 nm at 50 mg (220) to about 655 nm at 100 mg (230) and about 670 nm at 200 mg (240), indicating QD aggregation.

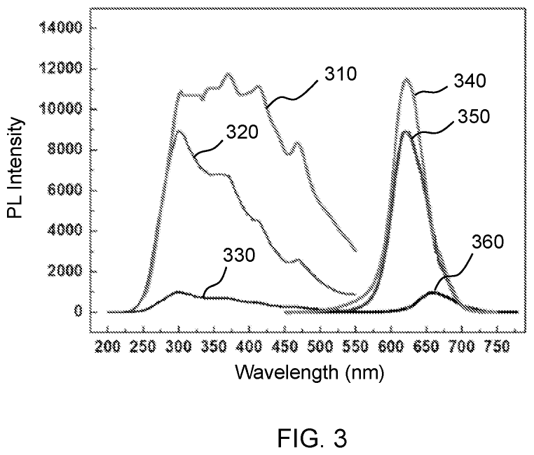

FIG. 3 compares the PL intensity of a QD solution (310), a QD composition including polymer beads (320) and a QD cast film (330). Normalized graphs are also shown for these examples (340, 350 and 360, respectively). As shown, the PL intensity of the QD composition including polymer beads is substantially higher (about 9×) than that of the QD cast film (compare 320/350 to 330/360). In addition, the peak wavelength of the QD composition including polymer beads is not red-shifted as compared to that of the QD solution (compare 320/350 to 310/340). This shows that the QD composition including polymer beads is ideally dispersed. As the QDs aggregate (see the cast film, 330/360), the peak wavelength shifts and PL intensity decreases.

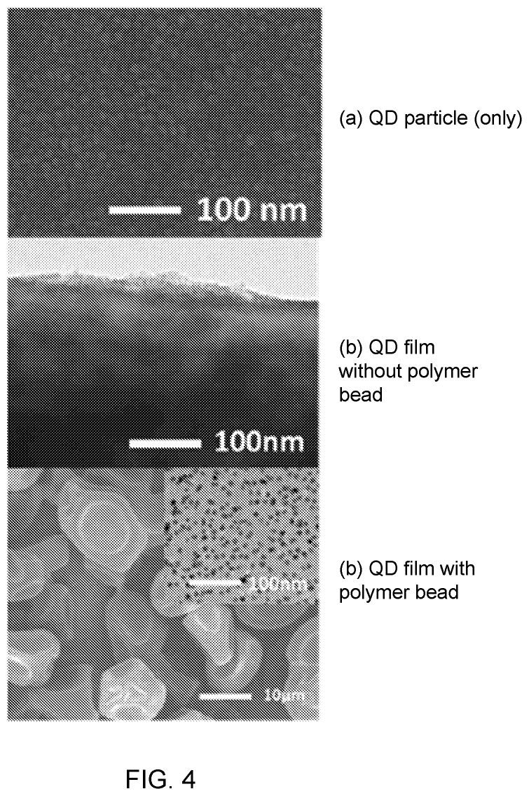

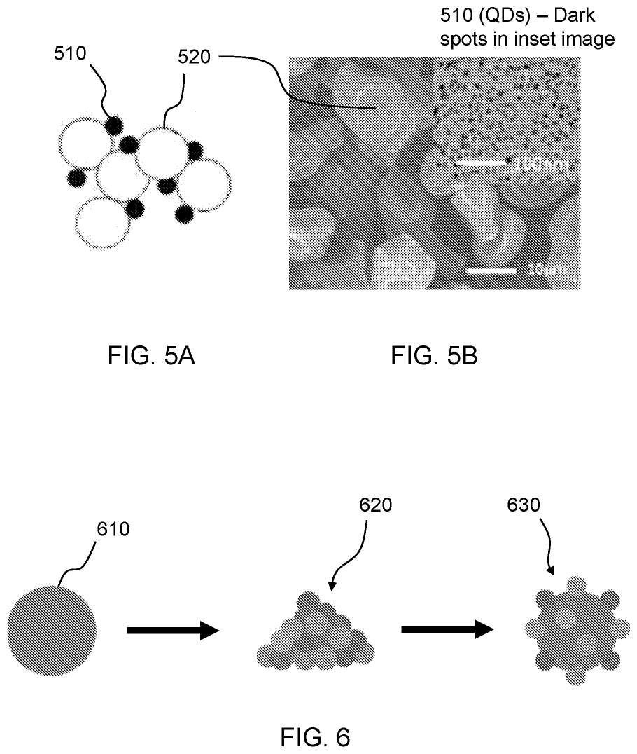

FIG. 4 provides exemplary SEM images of casted film without polymer beads (b) and with polymer beads (c) (including the inset image). QD particles are shown in (a). See also FIG. 5A for a representation of QDs 510 and polymeric beads 520, and FIG. 5B, which is the SEM image from FIG. 4(c) annotated to show the polymeric beads 520 and the QDs 510 (the dark spots in the 100 nm scale inset image). A schematic representation of dispersion of QDs (620) around a polymeric bead (610) is shown in FIG. 6.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1-20. (canceled)

21. A composition, comprising
a population of quantum dots disposed on a population of polymeric particles, one or more organic ligands being disposed on surfaces of the quantum dots, the one or more organic ligands mediating disposition of the quantum dots on the population of polymeric particles,
the population of polymeric particles being dispersed in a matrix material, and
the one or more quantum dots comprising
Zn₃P₂, Zn₃As₂, Cd₃P₂, Cd₃As₂, Cd₃N₂, Zn₃N₂, or any combination thereof,
B₄C, Al₄C₃, Ga₄C, or any combination thereof, or
Al₂S₃, Al₂Se₃, Al₂Te₃, Ga₂S₃, Ga₂Se₃, In₂S₃, In₂Se₃, Ga₂Te₃, In₂Te₃, or any combination thereof.

22. The composition of claim 21, wherein the organic ligand comprises an amine, a carboxylic acid, a thiol, a phosphine, a pyridine, or any combination thereof.

23. The composition of claim 21, wherein the organic ligand comprises a C6-C30 alkylamine, a carboxylic acid, a thiol, or any combination thereof.

24. The composition of claim 21, wherein the organic ligand has a molecular weight of from about 90 to about 350 g/mol.

25. The composition of claim 21, wherein the polymeric particles comprise one or more of: acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN), and polymethylmethacrylate polymer (PMMA).

26. The composition of claim 21, wherein the population of polymeric particles has a mean size, on a number average basis, in a range of from about 100 nm to about 10 micrometers.

27. The composition of claim 21, wherein the population of quantum dots further comprises MgS, MgSe, MgTe, CaS, CaSe, CaTe, SrS, SrSe, SrTe, CdS, CdSe, CdTe, ZnS, ZnSe, ZnTe, HgS, HgSe, HgTe, or any combination thereof.

28. The composition of claim 21, wherein the population of quantum dots comprises PbS, PbSe, PbTe, SnS, SnSe, SnTe, or any combination thereof.

29. The composition of claim 21, wherein the quantum dots are present at from about 0.5 to about 5 wt % per volume of the composition.

30. The composition of claim 21, wherein the polymeric particles are present at from about 5 to about 50 wt % per volume of the composition.

31. The composition of claim 21, wherein the composition in a form of a layer that defines a thickness in a range of from about 10 to about 500 micrometers.

32. The composition of claim 21, wherein the composition is characterized as having a photoluminescence intensity that increases with increasing quantum dot concentration at above the quantum dot concentration that corresponds to a maximum photoluminescence intensity in a corresponding reference composition that is free of the polymer particles and the organic ligands.

33. The composition of claim 21, wherein the composition is characterized as having, at a quantum dot concentration, a photoluminescence intensity that is greater than a maximum photoluminescence intensity of a corresponding reference composition that is free of the polymer particles and the organic ligands.

34. The composition of claim 21, wherein the composition is characterized as having, at a given quantum dot concentration, a photoluminescence intensity that is equal to a maximum photoluminescence intensity of a corresponding reference composition that is free of the polymer particles and the organic ligand, and wherein the given quantum dot concentration is lower than the quantum dot concentration that produces the maximum photoluminescence intensity of the corresponding reference composition.

35. A method of preparing a composition, comprising:
in a dispersion medium, contacting a population of quantum dots, an organic ligand, and a population of polymeric particles under such conditions that the quantum dots are dispersed on the population of polymeric particles, the organic ligand participating in the dispersion of the quantum dots on the polymeric particles, wherein the population of quantum dots comprise
Zn₃P₂, Zn₃As₂, Cd₃P₂, Cd₃As₂, Cd₃N₂, Zn₃N₂, or any combination thereof,
B₄C, Al₄C₃, Ga₄C, or any combination thereof, or
Al₂S₃, Al₂Se₃, Al₂Te₃, Ga₂S₃, Ga₂Se₃, In₂S₃, In₂Se₃, Ga₂Te₃, In₂Te₃, or any combination thereof.

36. A method, comprising dispersing, into a matrix material, a population of polymeric particles having disposed thereon a population of quantum dots bearing organic ligands, wherein the population of quantum dots comprise
Zn₃P₂, Zn₃As₂, Cd₃P₂, Cd₃As₂, Cd₃N₂, Zn₃N₂, or any combination thereof,
B₄C, Al₄C₃, Ga₄C, or any combination thereof, or
Al₂S₃, Al₂Se₃, Al₂Te₃, Ga₂S₃, Ga₂Se₃, In₂S₃, In₂Se₃, Ga₂Te₃, In₂Te₃, or any combination thereof.
